(19) United States
(12) Patent Application Publication
(10) Pub. No.: US 2024/0383148 A1
(43) Pub. Date: Nov. 21, 2024

(54) ROBOT AND METHOD FOR CONTROLLING SAME

(71) Applicant: LG ELECTRONICS INC., Seoul (KR)

(72) Inventors: Soonhong JUNG, Seoul (KR); Hyoungseok KIM, Seoul (KR)

(73) Assignee: LG ELECTRONICS INC., Seoul (KR)

(21) Appl. No.: 18/689,822

(22) PCT Filed: May 25, 2022
(86) PCT No.: PCT/KR2022/007417

§ 371 Date: Mar. 6, 2024

(30) Foreign Application Priority Data
Sep. 10, 2021 (KR) 10-2021-0121274
Sep. 10, 2021 (KR) 10-2021-0121275

(51) Int. Cl. B25J 9/16; B25J 13/08

(52) U.S. Cl. CPC B25J 9/1697; B25J 9/1661; B25J 13/08

(57) ABSTRACT

The present invention provides a robot and a method for controlling same. The robot according to an embodiment of the present invention may comprise: a light source unit including a plurality of light-emitting elements; a sensing unit which senses information related to a space from which light is output in the light source unit; and a control unit which makes the light source unit emit light so that an object existing in the space is recognized through the sensing unit, wherein the control unit makes at least one of the plurality of light-emitting elements emit light such that a light pattern that causes a recognition rate for recognizing the object, to be greater than or equal to a preset value, is irradiated to the space.

### TECHNICAL FIELD

The present disclosure relates to a robot that recognizes objects using lighting and a method for controlling the same.

### BACKGROUND ART

Recently, with the commercialization of lamps that can emit light to desired areas, development of technologies that a lamp moves to correspond to a direction the lamp is to move or finds an area where an object is present to emit light to the found area is undergoing.

For example, dynamic lighting may be implemented using head lamps in a vehicle. As for the vehicle, a direction in which the vehicle can travel is predictable to some extent by an operation of driving the vehicle, and the position of lighting is also predictable.

On the other hand, since a robot has a much higher degree of freedom of movement, an area that needs to be covered with lighting becomes wider than that of the vehicle.

Additionally, due to a trouble of dynamically predicting environmental changes such as ambient lighting and weather, it is difficult to provide lighting of desired intensity to be suitable for all situations.

Devices that require such object recognition may include terminals, vehicles, and robots.

Robots may be classified into mobile/portable robots and stationary robots depending on whether they can move. Also, the robots may be classified into handheld robots and vehicle mounted robots depending on whether or not users can directly carry.

The functions of robots are diversifying. Examples of those functions include data and voice communication, photography and video shooting using cameras, voice recording, music file playback through a speaker system, and outputting images or videos to displays. Some robots additionally have electronic game play functions or perform multimedia player functions. In particular, modern robots can receive broadcast and multicast signals that provide visual contents such as videos or television programs.

As it becomes multifunctional, a robot may be allowed to capture still images or moving images, play music or video files, play games, receive broadcast and the like, so as to be implemented as an integrated multimedia player.

Efforts are ongoing to support and increase the functionality of robots. Such efforts include software and hardware improvements, as well as changes and improvements in the structural components.

### DISCLOSURE OF INVENTION

### Technical Problem

One aspect of the present disclosure is to provide a robot that is capable of recognizing objects in an optimized manner, and a method for controlling the same.

Another aspect of the present disclosure is to provide a robot that is capable of securing an optimized object class probability by controlling lighting, and a method for controlling the same.

### Solution to Problem

A robot according to an embodiment of the present disclosure robot includes: a light source unit that has a plurality of light-emitting elements; a sensing unit that senses information related to a space to which light is output from the light source unit; and a control unit that controls the light source unit to emit light to recognize objects existing in the space through the sensing unit, wherein the control unit controls at least one of the plurality of light-emitting elements to emit light so that a light pattern that causes a class probability of recognizing the objects to be higher than or equal to a preset value is irradiated to the space.

In an embodiment, the plurality of light-emitting elements may each be configured to emit light into different spaces, and a light pattern of the emitted light may vary when an element emitting light among the plurality of light-emitting elements changes.

In an embodiment, the sensing unit may recognize the object based on light emitted from the light source unit being reflected back from the object, and the class probability for recognizing the object may vary when the light pattern of the light output from the light source unit changes.

In an embodiment, the robot may further include a memory that stores information related to a space and information related to a light pattern in association with each other, and the control unit may determine whether the sensed information related to the space exists in the memory, based on the information related to the space sensed by the sensing unit.

In an embodiment, when the sensed information related to the space exists in the memory, the control unit may control the plurality of light-emitting elements to emit light based on the information related to the light pattern associated with the sensed information related to the space.

In an embodiment, the control unit may control at least some of the plurality of light-emitting elements to emit light with a light pattern corresponding to the information related to the light pattern linked to the sensed information related to the space.

In an embodiment, when the sensed information related to the space is not present in the memory, the control unit may randomly control at least some of the plurality of light-emitting elements to emit a plurality of random light patterns to the space, such that a light pattern causing the class probability for recognizing the object to be higher than or equal to a preset value is irradiated to the space.

In an embodiment, when a certain light pattern, among the plurality of random light patterns, causes the class probability for recognizing the object to be higher than or equal to the preset value, the control unit may store information related to the certain light pattern in the memory.

In an embodiment, the information related to the certain light pattern may include information related to a light-emitting element that must emit light to generate the certain light pattern.

In an embodiment, the information related to the certain light pattern may be stored in the memory in association with the sensed information related to the space.

In an embodiment, the control unit may sense a motion of the object existing in the space through the sensing unit and predict an area where the object is to be located after a predetermined time based on the sensed motion.

In an embodiment, when the object is located in the predicted area, the control unit may control at least one of the plurality of light-emitting elements to irradiate a light pattern, which causes the class probability of recognizing the object to be higher than or equal to the preset value, to the predicted area.

In an embodiment, the control unit may increase the preset value when the robot is in a stationary state without movement, while decreasing the preset value when the robot moves.

In an embodiment, the control unit may irradiate a light pattern causing the class probability to be higher than or equal to a preset value while tracking the object existing in the space using the sensing unit, and generate a new light pattern when the object being tracked disappears.

In an embodiment, when at least one of light emitting elements for emitting the light pattern fails, the control unit may control at least one of the light-emitting elements, adjacent to the failed light-emitting element, to emit light and control the at least one of the adjacent light-emitting elements to emit a light pattern corresponding to the light pattern.

A robot according to another embodiment of the present disclosure includes: a light source unit that has a plurality of light-emitting elements; a sensing unit that senses information related to a space to which light is output from the light source unit; and a control unit that controls the light source unit to emit light to recognize an object existing in the space through the sensing unit, wherein the control unit, when a plurality of objects exist in the space, determines whether types of the objects existing in the space are the same, and controls the light source unit to recognize the objects existing in the space in a first object recognition mode or a second object recognition mode based on a result of the determination.

In an embodiment, the control unit may recognize the plurality of objects existing the space in the first object recognition mode when the plurality of objects existing in the space are of different types, and recognize the plurality of objects existing the space in the second object recognition mode when the plurality of objects existing in the space are of the same type.

In an embodiment, the first object recognition may be a mode of extracting object class probabilities for each type, and recognizing the objects based on the object class probabilities extracted for each type.

In an embodiment, in the first object recognition mode, the control unit may extract the object class probabilities for each type and control the light source unit so that an average of the extracted object class probabilities for each type exceeds a threshold for each type.

In an embodiment, when entering the first object recognition mode, the control unit may control at least some of the plurality of light-emitting elements to emit light, to determine a light pattern that causes the average of the object class probabilities for each type to exceed the threshold for each type.

In an embodiment, the second object recognition mode may be a mode of recognizing objects based on class probabilities for the plurality of objects of the same type.

In an embodiment, in the second object recognition mode, the control unit extract a class probability for each of a plurality of objects and control the light source unit so that an average of the extracted class probabilities exceeds a threshold.

In an embodiment, when entering the second object recognition mode, the control unit may control at least some of the plurality of light-emitting elements to emit light, to determine a light pattern that causes the average of the object class probabilities of the plurality of objects to exceed the threshold.

In an embodiment, in the first object recognition mode, the control unit may control the light source unit based on an object class probability of a type with a highest priority, with respect to different types of objects.

In an embodiment, the control unit may control the light source unit to emit a light pattern that causes the object class probability of the type with the highest priority exceeds the threshold.

In an embodiment, the control unit may vary a threshold of an object class probability based on the types of the plurality of objects in the first object recognition mode.

In an embodiment, the control unit may set the threshold for recognizing the objects to a first threshold, and when a preset type of object is included in the plurality of objects, set the threshold to a second threshold higher than the first threshold.

In an embodiment, when the preset type of object is included in the plurality of objects, the control unit may control the light source unit to irradiate a light pattern that causes the object class probability is higher than the second threshold.

### Advantageous Effects of Invention

Hereinafter, effects of a robot and a method for controlling the same according to the present disclosure will be described.

According to at least one of embodiments of the present disclosure, a new robot that is capable of maintaining an object class probability to be higher than a threshold by utilizing lighting when recognizing objects, and a method for controlling the same can be provided.

The present disclosure can perform object recognition in an optimized manner by performing lighting control differently depending on types of objects even when a plurality of objects exist.

Further scope of applicability of the present disclosure will become apparent from the following detailed description. However, since it could be clearly understood by those skilled in the art various changes and modifications are made within the spirit and scope of the present disclosure, the detailed description and specific embodiments such as preferred embodiments of the present disclosure should be understood as being given only as examples.

### BRIEF DESCRIPTION OF DRAWINGS

FIG. 1 is a block diagram for explaining a robot in accordance with the present disclosure.

FIGS. 2A and 2B are conceptual diagrams for explaining a light source unit disposed in a robot in accordance with the present disclosure.

FIGS. 3A and 3B are conceptual diagrams for explaining a plurality of light-emitting elements disposed in a light source unit in accordance with the present disclosure.

FIG. 4 is a flowchart illustrating a representative control method in accordance with the present disclosure.

FIGS. 5, 6A, and 6B are conceptual diagrams for explaining the control method illustrated in FIG. 4.

FIG. 7 is a flowchart for explaining an object recognition method in accordance with one embodiment of the present disclosure.

FIGS. 8, 9, 10, 11, 12, 13, and 14 are conceptual diagrams and flowcharts for explaining the control method illustrated in FIG. 7.

FIGS. 15, 16, and 17 are conceptual diagrams and a flowchart for explaining an object recognition method in accordance with another embodiment of the present disclosure.

FIGS. 18, 19, 20, 21, 22, 23, 24, and 25 are conceptual diagrams and flowcharts for explaining various object recognition methods in accordance with the present disclosure.

### MODE FOR THE INVENTION

Description will now be given in detail according to one or more embodiments disclosed herein, with reference to the accompanying drawings. For the sake of brief description with reference to the drawings, the same or equivalent components may be provided with the same or similar reference numbers, and description thereof will not be repeated. A suffix “module” or “unit” used for elements disclosed in the following description is merely intended for easy description of the specification, and the suffix itself is not intended to give any special meaning or function. In describing the embodiments disclosed herein, moreover, the detailed description will be omitted when specific description for publicly known technologies to which the invention pertains is judged to obscure the gist of the present disclosure. The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions, or steps, disclosed in the specification, and it is also understood that greater or fewer components, functions, or steps may likewise be utilized.

In the present disclosure, the description of a robot may also be applied in the same/similar way not only to all types of devices each having a movable main body, such as mobile terminals, vehicles, and cleaners, but also to all types of devices each equipped with a function of recognizing objects (e.g., CCTV, mobile cameras, depth information measurement devices, 3D cameras, etc.).

Robots presented herein may be implemented using a variety of different types of devices. Examples of such devices include cellular phones, smart phones, laptop computers, digital broadcasting robots, personal digital assistants (PDAs), portable multimedia players (PMPs), navigators, slate PCs, tablet PCs, ultra books, wearable devices (for example, watch-type robots, (smart watches), glass-type robots (smart glasses), head mounted displays (HMDs)), and the like.

By way of non-limiting example only, further description will be made with reference to particular types of robots. However, such teachings apply equally to other types of robots, such as those types noted above. In addition, these teachings may also be applied to stationary robots such as digital TVs, desktop computers, digital signages, and the like.

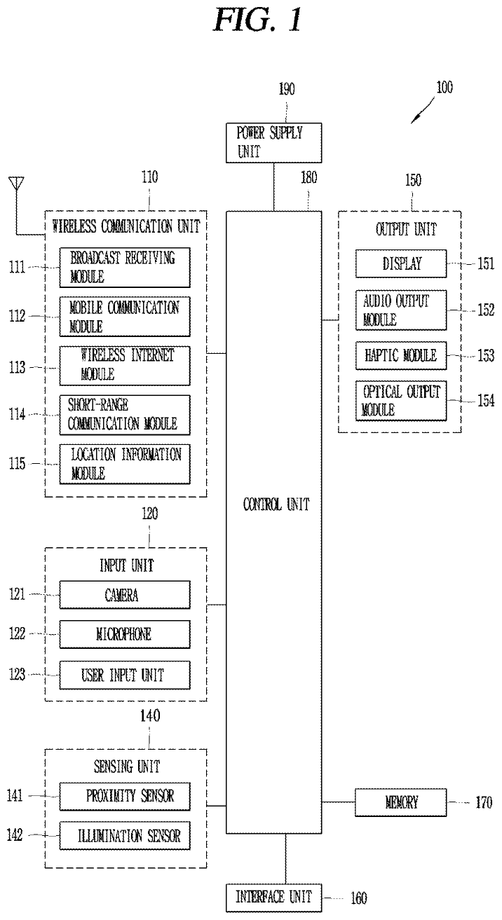

FIG. 1 is a block diagram for explaining a robot in accordance with the present disclosure.

The robot 100 may include components, such as a wireless communication unit 110, an input unit 120, a sensing unit 140, an output unit 150, an interface unit 160, a memory 170, a control unit 180, a power supply unit 190, and the like. The components illustrated in FIG. 1A are not essential for implementing the robot, and thus the robot described herein may have more or fewer components than those listed above.

In more detail, the wireless communication unit 110 of those components may typically include one or more modules which permit wireless communications between the robot 100 and a wireless communication system, between the robot 100 and another robot 100, or between the robot 100 and an external server. Further, the wireless communication unit 110 may typically include one or more modules which connect the robot 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio (voice) input device for inputting an audio signal, and a user input unit 123 (for example, a touch key, a mechanical key, and the like) for allowing a user to input information. Voice data or image data collected by the input unit 120 may be analyzed and processed as a user's control command.

The sensing unit 140 may typically be implemented using one or more sensors configured to sense at least one of internal information regarding the robot, surrounding environment information around the robot, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). On the other hand, the robot disclosed herein may use information in such a manner of combining information sensed by at least two sensors of those sensors.

The output unit 150 may be configured to output an audio signal, a video signal or a tactile signal. The output unit 150 may include a display 151, an audio output module 152, a haptic module 153, an optical output unit 154 and the like. The display 151 may have an inter-layered structure or an integrated structure with a touch sensor in order to facilitate a touch screen. The touch screen may function as a user input unit 123 which provides an input interface between the robot 100 and the user and simultaneously provide an output interface between the robot 100 and the user.

The interface unit 160 may serve as an interface with various types of external devices connected with the robot 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. The robot 100 may perform assorted control functions related to a connected external device, in response to the external device being connected to the interface unit 160.

Also, the memory 170 may store data to support various functions of the robot 100. The memory 170 may store a number of application programs (application programs or applications) running on the robot 100, and data and commands for operating the robot 100. At least some of these applications may be downloaded from an external server via wireless communication. Additionally, at least some of these applications may be present on the robot 100 from the time of shipment for the basic functions of the robot 100 (e.g., call incoming and outgoing functions, message receiving and sending functions). On the other hand, the application programs may be stored in the memory 170, installed in the robot 100, and executed by the control unit 180 to perform the operation (or a function) of the robot 100.

The control unit 180 typically functions to control an overall operation of the robot 100, in addition to the operations associated with the application programs. The control unit 180 may provide or process information or functions appropriate for the user by processing signals, data, information, and the like, which are input or output by the aforementioned various components, or activating application programs stored in the memory 170.

Also, the control unit 180 may control at least some of the components illustrated in FIG. 1A to run application programs that are stored in the memory 170. In addition, the control unit 180 may control at least two of those components included in the robot 100 to activate the application program.

The power supply unit 190 may be configured to receive external power or provide internal power in order to supply appropriate power required for operating elements and components included in the robot 100. The power supply unit 190 may include a battery, and the battery may be configured as an embedded battery or a detachable battery.

At least some of those components may operate in a collaborative manner to implement operations, controls, or control methods for the robot according to various embodiments to be described below. Additionally, the operations, controls, or control methods for the robot may be implemented on the robot by running at least one application program stored in the memory 170.

Hereinafter, embodiments related to control methods that can be implemented in the robot configured as described above will be described with reference to the accompanying drawings. It will be apparent to those skilled in the art that the present disclosure may be embodied in other specific forms without departing from the spirit or essential characteristics thereof.

The robot 100 related to the present disclosure may extract depth information from an image received through the camera 121 (see FIG. 1A). Additionally, the robot 100 may recognize objects existing around the robot using the image received through the camera.

The image received through the camera may be called a preview image. Specifically, the preview image refers to an image received through the camera in real time. The preview image may change as the robot equipped with the camera 121 moves due to an external force or a subject to be captured moves.

The depth information may be named depth value, depth-related information, etc. The depth information may refer to a distance (or distance value) between a subject corresponding to a pixel included in the image and the robot (more specifically, the camera).

For example, if the distance between the robot and a subject corresponding to a specific pixel of the image is n, depth information related to the specific pixel may be a specific value corresponding to n. The specific value corresponding to n may be n or may be a value converted by a preset algorithm.

Additionally, when the coordinates of the image are set with an x-axis and a y-axis perpendicular to the x-axis, the depth information may refer to a value corresponding to a z-axis perpendicular to each of the x-axis and the y-axis. The absolute value of the depth information may increase as the distance between the subject and the robot increases.

This depth information may be used in various fields. As an example, the depth information may be used to photograph/generate 3D stereoscopic images, to generate 3D printing data used in a 3D printer, or to monitor the movement of objects (subjects) around the robot.

The robot related to the present disclosure may extract depth information from images received through the camera in various ways. For example, the control unit 180 (see FIG. 1A) may extract depth information through a stereo vision scheme of extracting depth information using at least two cameras, a structured light scheme of extracting depth information using light-emitting elements disposed to form a preset pattern, a time of flight (ToF) scheme of extracting depth information on the basis of time that is taken for light emitted from a light-emitting element to return after being reflected, or any combination thereof.

Hereinafter, a description will focus on extracting depth information using the structured light scheme among those schemes.

The structured light scheme is a method of emitting light to a subject by controlling a plurality of light-emitting elements disposed to have a preset pattern, sensing light reflected from the subject, and extracting depth information on the basis of the sensed light (or the pattern of the sensed light). For example, the control unit 180 of the robot related to the present disclosure may control the plurality of light-emitting elements disposed to have the preset pattern to emit light toward the subject. Afterwards, the control unit 180 of the robot may detect (sense) the light reflected by the subject through the camera 121 or the sensing unit 140 (see FIG. 1).

At this time, the control unit 180 may extract depth information related to an image received through the camera 121 based on the detection result. For example, the control unit 180 may extract the depth information related to the image received through the camera 121 by comparing the preset pattern with a pattern, which is formed by the reflected light, or comparing time/intensity for the light to be reflected and returned after being emitted. To this end, the plurality of light-emitting elements may be configured to emit light to a space corresponding to the image received through the camera 121.

The preset pattern may be determined (set) by the user or may be predetermined when producing the product of the robot. Additionally, the preset pattern may be changed by the user's request or the control by the control unit.

Also, the plurality of light-emitting elements may emit infrared light. Also, the light-emitting elements may be laser diodes changing an electrical signal into an optical signal. For example, the light-emitting elements may be vertical cavity surface emitting lasers (VCSELs).

In the present disclosure, the use of the structured light method may enable the extraction of the depth information regarding the image through only one camera (an infrared camera or 3D camera), and also enable the extraction of the depth information even when the subject has a single color. Additionally, the accuracy of depth information may be improved by combining the structured light method and the stereo vision method using at least two cameras, or by combining the structured light method and the ToF method.

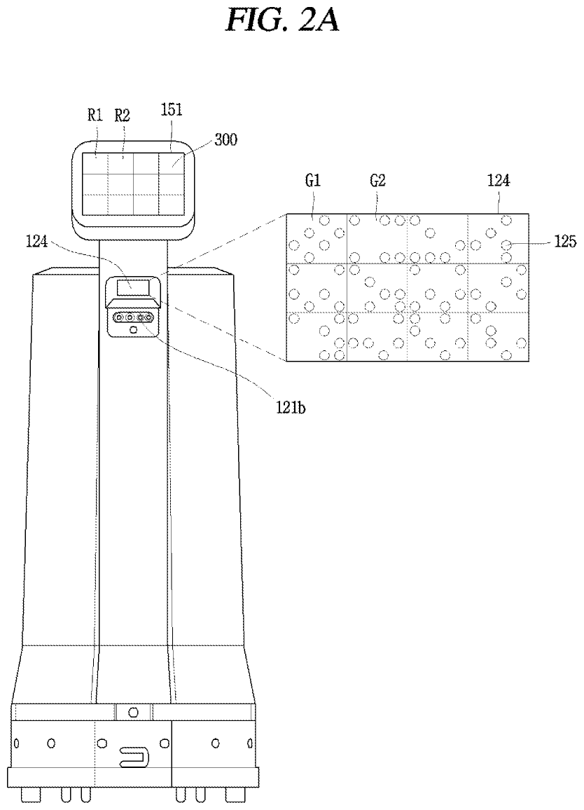

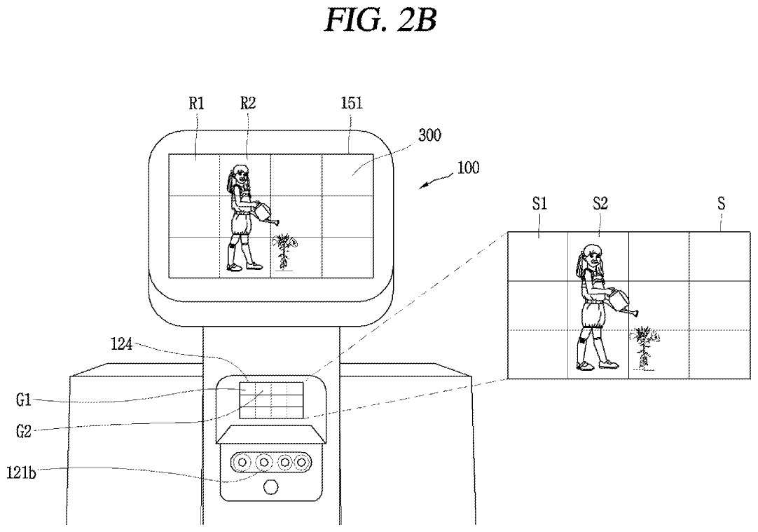

FIGS. 2A and 2B are conceptual diagrams for explaining a light source unit disposed in a robot in accordance with the present disclosure, and FIGS. 3A and 3B are conceptual diagrams for explaining a plurality of light-emitting elements disposed in the light source unit in accordance with the present disclosure.

The robot 100 related to the present disclosure may be equipped with a light source unit 124. The light source unit 124 may be the same as the flash 124 described above, or may be a separate component. Hereinafter, reference numeral 124 will be used for denoting the light source unit.

The light source unit 124 may include at least one light-emitting element 125. Specifically, the light source unit 124 may include a plurality of light-emitting elements 125, and the plurality of light-emitting elements 125 may be disposed in various ways. Details related to the disposition of the plurality of light-emitting elements 125 will be described later with reference to FIGS. 3A and 3B.

The light source unit 124 may be disposed adjacent to the camera 121. For example, the light source unit 124 may be disposed adjacent to a camera 121b, as illustrated in FIG. 2A. Although not illustrated, the light source unit 124 may be formed integrally with the camera 121b.

The plurality of light-emitting elements 125 included in the light source unit 124, as described above, may be VCSELs, which are one of infrared diodes. Each light-emitting element may emit infrared rays toward a subject. For example, emitting light from the light-emitting element may mean emitting infrared rays from a big cell. Additionally, emitting light from the light-emitting element may be understood as meaning projecting light having a wavelength in a specific range.

The camera 121b may be a 3D camera or an infrared camera used to extract depth information. The camera 121b may include an IR (Infrared Ray) pass filter through which infrared rays received from outside pass, and an image sensor capable of detecting infrared rays. The image sensor may be implemented in the form of a charge-coupled device (CCD) or a complementary mental-oxide semiconductor (CMOS).

Additionally, the camera 121b may be used to recognize an object and may be included in the sensing unit 160.

The camera 121b may detect infrared rays received from outside, that is, infrared rays which are reflected back from a subject after being emitted from the light-emitting elements included in the light source unit to the subject. In addition, the control unit 180 of the robot related to the present disclosure may detect infrared rays through the sensing unit 140 (e.g., an infrared sensor (IR sensor)). Additionally, the camera 121b may detect light having a specific wavelength.

Meanwhile, the light source unit 124 may be configured to emit light to a space corresponding to an image received through the camera 121b. Specifically, the plurality of light-emitting elements 125 included in the light source unit 124 may emit light into a space corresponding to an image 300 received through the camera.

Here, the space corresponding to the image 300 received through the camera may mean a space (the view of a scene) captured by the camera, in a space (real space) except for a space occupied by the robot 100. For example, the space corresponding to the image received through the camera may be determined based on an angle of view (field of view) of the camera.

For example, a specific light-emitting element among the plurality of light-emitting elements may be configured to emit light to a space corresponding to a specific pixel(s) (a portion) of the image received through the camera.

Meanwhile, the plurality of light-emitting elements 125 included in the light source unit 124 of the present disclosure may be grouped into a plurality of groups. Each of the plurality of groups may include at least two light-emitting elements. Specifically, the control unit 180 may control the plurality of light-emitting elements 125 individually or in units of groups including the at least two light-emitting elements. The plurality of light-emitting elements may be grouped into groups having various shapes, and the shape of each group may be determined by user settings or the control by the control unit.

For example, as illustrated in FIG. 2A, light-emitting elements included in a first group G1 among a plurality of groups G1, G2, . . . included in the light source unit 124 may emit light to a space corresponding to a first area R1 in the image 300 received through the camera 121b.

In addition, light-emitting elements included in a second group G2, different from the first group G1, among the plurality of groups G1, G2, . . . included in the light source unit 124 may emit light to a space corresponding to a second area R2 in the image 300 received through the camera 121b.

More specifically, referring to FIG. 2B, the image 300 received through the camera may be output to the display 151 of the robot related to the present disclosure. The image 300 may be an image corresponding to a space (view of a scene, subject) S captured by the camera.

Additionally, the light source unit 124 of the robot related to the present disclosure may be configured to emit light to the space S corresponding to the image 300.

The light source unit 124 may include a plurality of light-emitting elements, and the plurality of light-emitting elements may be grouped into a plurality of groups G1, G2, . . . . The light-emitting elements included in the respective groups may be configured to emit light to spaces corresponding to different areas of the image 300.

For example, the light-emitting elements included in the first group G1 of the plurality of groups may emit light to a space S1 corresponding to the first area R1 of the image 300, and the light-emitting elements included in the second group G2 among the plurality of groups may emit light to a space S2 corresponding to the second area R2 of the image 300.

To this end, the light source unit 124 related to the present disclosure may further include a lens. The lens may refract or diffuse light emitted from the light source unit 124. The lens may be one lens corresponding to the light source unit 124, may be a plurality of lenses disposed to correspond to the plurality of groups included in the light source unit 124, or may be a plurality of lenses disposed to correspond to the plurality of light-emitting elements included in the light source unit 124.

The lens may be controlled by the control unit 180 to emit light output from the light source unit 124 to a space corresponding to the image received through the camera. Specifically, when the size of the light source unit 124 is larger than the size of the space S corresponding to the image 300 received through the camera, the control unit 180 may control the lens to emit light from the light source unit 124 to correspond to the space s. To this end, the lens may be formed so that its curvature or its position is changed.

Meanwhile, the plurality of light-emitting elements included in the light source unit 124 related to the present disclosure may be disposed to form a preset pattern. Through this, in the present disclosure, depth information regarding the image received through the camera can be extracted by the structured light method.

To this end, the plurality of light-emitting elements 125 may be disposed or controlled in various ways.

As an example, referring to FIG. 3A, the light source unit 124 related to the present disclosure may include the plurality of light-emitting elements that are disposed in a matrix configuration at preset intervals. The control unit 180 may cause only some of the plurality of light-emitting elements to emit light so that a preset pattern is formed.

For example, the control unit 180 may control the light source unit 124 to emit light only from some of the light-emitting elements 125a among the plurality of light-emitting elements 125 that are disposed in a 4 by 4 configuration to produce a preset pattern Pa1.

As described above, the plurality of light-emitting elements 125 may be grouped into the plurality of groups. The light-emitting elements included in the plurality of groups may be controlled to form different patterns. For example, the control unit 180 may control the light-emitting elements to emit light to have a first pattern in a first group among the plurality of groups, and control the light-emitting elements to emit light to have a second pattern, different from the first pattern, in a second group different from the first group, among the plurality of groups.

As another example, referring to FIG. 3B, the plurality of light-emitting elements may be disposed to have a preset pattern in the light source unit 124 related to the present disclosure. In this instance, the plurality of light-emitting elements may be disposed to form a different pattern for each group.

For example, among a plurality of groups, light-emitting elements included in a first group may be disposed to form a first pattern Pa2, light-emitting elements included in a second group may be disposed to form a second pattern Pa3, light-emitting elements included in a third group may be disposed to form a third pattern Pa4. Here, the first to third patterns may be different.

In the above, the case where the light-emitting elements for each group are disposed or controlled to form a specific pattern has been described. However, the present disclosure is not limited to this, and all of the plurality of light-emitting elements included in the light source unit 124 may be disposed or controlled to form a specific pattern.

In addition, as described in FIGS. 2A and 2B, light-emitting elements, which emit light to the space corresponding to the portion of the image received through the camera, among the plurality of light-emitting elements, or light-emitting elements included in a group, which emit light to the space corresponding to the portion of the image, among the plurality of groups, may be at least two light-emitting elements formed (disposed) in a preset pattern, as illustrated in FIGS. 3A and 3B.

That is, in the present disclosure, when extracting depth information regarding a specific portion of the image received through the camera, the control unit may control light-emitting elements (or light-emitting elements included in a group), which are configured to emit light to the space corresponding to the specific portion, among the plurality of light-emitting elements (or the plurality of groups) included in the light source unit 124, to emit light.

Here, the light-emitting elements configured to emit light to the space corresponding to the specific portion may be formed (disposed) in a preset pattern. Accordingly, the light emitted from the light-emitting elements formed in the preset pattern in the light source unit 124 may be projected into the space corresponding to the specific portion. The light projected into the space may be reflected back to the robot.

Thereafter, in the present disclosure, an object may be recognized based on the light reflected back from the space.

The robot of the present disclosure, which may include at least one of the components discussed above, may recognize an object using the image received through the camera in an optimized way, and for this purpose, the plurality of light-emitting elements included in the light source unit 124 may be controlled in units of groups.

Hereinafter, a method for controlling a light source unit according to one embodiment of the present disclosure will be described in more detail with reference to the attached drawings.

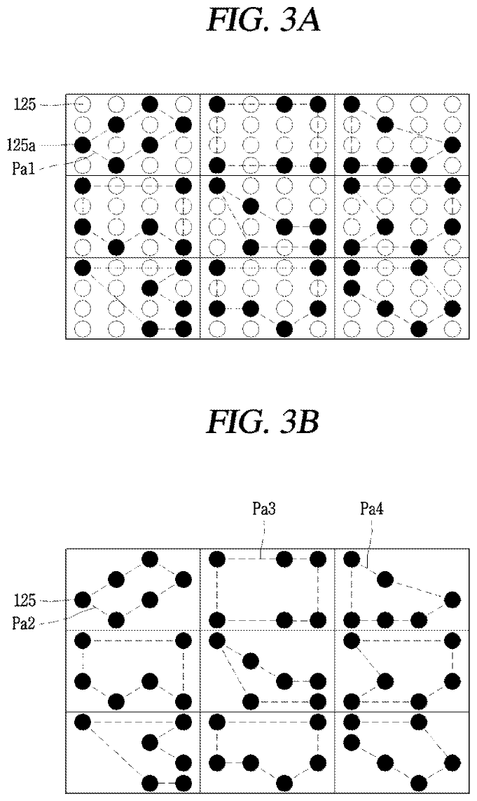

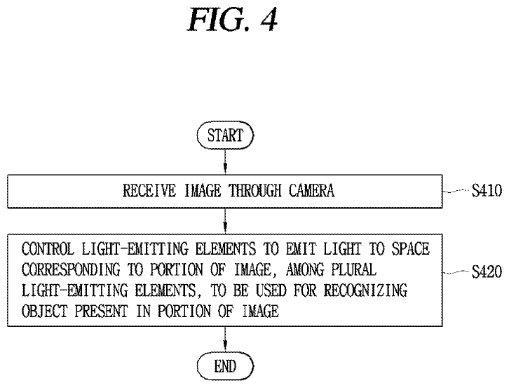

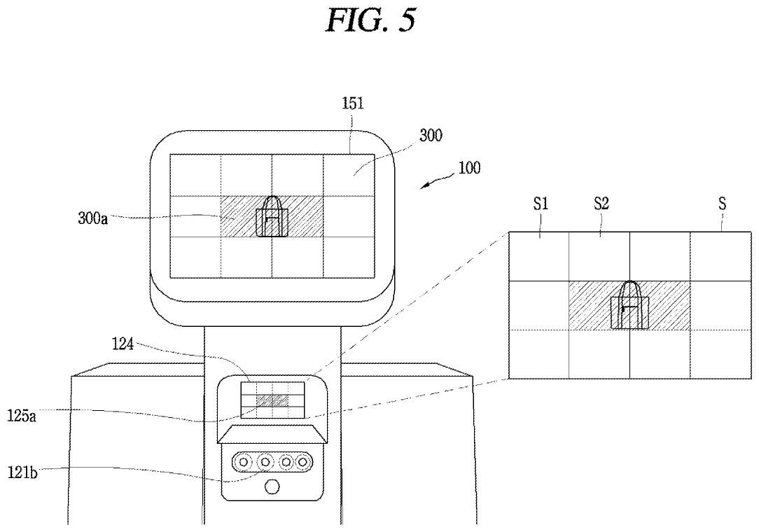

FIG. 4 is a flowchart illustrating a representative control method in accordance with the present disclosure, and FIGS. 5, 6A, and 6B are conceptual diagrams for explaining the control method illustrated in FIG. 4.

First, referring to FIG. 4, in the present disclosure, a step of receiving an image through a camera is performed (S410). The image received through the camera may be output to the display 151. The camera may be activated based on a user request.

For example, the camera may be activated, in response to the execution of a camera-related application.

Thereafter, in the present disclosure, light-emitting elements that emit light into a space corresponding to a portion of the image, among a plurality of light-emitting elements, may be controlled to emit light to be used for recognizing an object present in the portion of the image (S420).

As described above, the light source unit 124 according to the present disclosure may include a plurality of light-emitting elements. To this end, the plurality of light-emitting elements may be configured to emit light to a space corresponding to the image received through the camera 121.

Specifically, the control unit 180 may select (set, designate) a portion of the image 300 received through the camera, as illustrated in FIG. 5. The portion may be selected based on the user's request or may be selected based on satisfaction of preset conditions.

For example, the portion may indicate an area where an object to be recognized through image analysis exists.

For example, in a state where the image 300 received through the camera is output to the display 151, the control unit 180 may select the portion based on a point (area, part) at which a touch is applied to the image 300.

As another example, the control unit 180 may select a preset area from the image received through the camera as the portion. The preset area may mean an area preset by the user.

As still another example, the control unit 180 may select, as the portion, an area with depth information within a preset range, from the image received through the camera. Alternatively, when the image is divided into a plurality of areas to correspond to the plurality of groups disposed in the light source unit 124, the portion may be at least one area, which includes an area with the depth information within the preset range, among the plurality of areas.

Additionally, the portion may be set or changed, in response to the image being captured or the robot being moved by an external force.

As another example, the control unit 180 may select an area, in which an object sensed through the sensing unit 140 exists, as the portion.

Referring back to FIG. 5, when a portion 300a of the image 300 received through the camera is selected, the control unit 180 may control light-emitting elements 125a, which are configured to emit light into a space Sa corresponding to the portion 300a, among the plurality of light-emitting elements included in the light source unit 124, to emit light.

In other words, the control unit 180 may group the plurality of light-emitting elements included in the light source unit 124 into a plurality of groups, and control the light-emitting elements 125a included in a group, which emits light into the space Sa corresponding to the portion 300a, among the plurality of groups, to emit light.

The light-emitting elements 125a may be disposed to form a preset pattern, and light may be projected into the space Sa corresponding to the portion 300a to form the preset pattern. The control unit 180 may detect light reflected back from the space through the camera or the sensing unit, and extract depth information related to the portion of the image based on the detection result. As such, the structured light method of extracting depth information using light forming a preset pattern is a general technology, and thus a detailed description thereof will be omitted.

As discussed above, the light-emitting elements (or group) included in the light source unit, the image received through the camera, and the space corresponding to the image may have a mutually corresponding relationship.

With this configuration, in the present disclosure, when an object present in a portion of an image received through the camera is recognized, all of the plurality of light-emitting elements disposed in the light source unit may not emit light, but some light-emitting elements, which are configured to emit light into a space corresponding to the portion, may emit light, thereby reducing power consumption and lowering peak power.

The light source unit 124 related to the present disclosure may include a plurality of light-emitting elements, and the plurality of light-emitting elements may be grouped into a plurality of groups.

When attempting to recognize an object in a portion of the image 300 received through the camera, the control unit 180 of the robot related to the present disclosure may control light-emitting elements included in a group, which is configured to emit light into a space corresponding to the portion, among the plurality of groups, to emit light.

Specifically, when depth information related to a first portion of the image 300 is extracted, the control unit 180 may control a first group of light-emitting elements, which are configured to emit light into a space corresponding to the first portion, among the plurality of groups, to emit light. In addition, when depth information related to a second portion of the image 300 is extracted, the control unit 180 may control a second group of light-emitting elements, which are configured to emit light into a space corresponding to the second portion, among the plurality of groups, to emit light.

For example, as illustrated in FIG. 6A, the image 300 received through the camera 121 may be divided (segmented) into a plurality of areas. Here, the plurality of areas may correspond to the plurality of groups, in which the plurality of light-emitting elements are grouped, in the light source unit 124.

When depth information regarding a first portion 601a of the image 300 (or a first area among the plurality of areas included in the image) is extracted, the control unit 180 may control light-emitting elements included in a group 601b, which is configured to emit light into a space corresponding to the first portion 601a, among the plurality of groups included in the light source unit 124, to emit light.

As another example, as illustrated in FIG. 6B, when depth information regarding a second portion 602a of the image 300 (or a second area among the plurality of areas included in the image) is extracted, the control unit 180 may control light-emitting elements included in a group 602b, which is configured to emit light into a space corresponding to the second portion 602a, among the plurality of groups included in the light source unit 124, to emit light.

Hereinafter, for convenience of explanation, the plurality of light-emitting elements grouped into the plurality of groups will be described as one light-emitting element.

For example, in the case of FIG. 6A, it may be understood that the light source unit 124 includes a plurality of light-emitting elements (12 light-emitting elements) with four arranged horizontally and three vertically.

In this case as well, each light-emitting element may be configured to emit light into a corresponding space.

Meanwhile, lighting (light) output from the light source unit is closely related to class probability (recognition rate, recognition probability) of recognizing an object. Hereinafter, a method for improving an object class probability when the robot recognizes an object will be described in more detail with reference to the accompanying drawings.

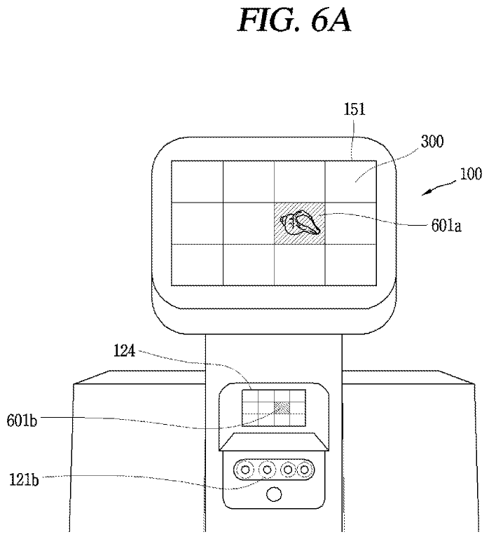

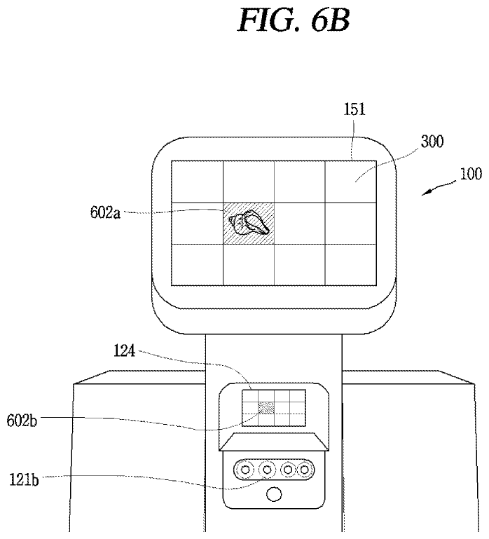

FIG. 7 is a flowchart for explaining an object recognition method in accordance with one embodiment of the present disclosure, and FIGS. 8, 9, 10, 11, 12, 13, and 14 are conceptual diagrams and flowcharts for explaining the control method illustrated in FIG. 7.

Referring to FIG. 7, a method for controlling a robot according to an embodiment of the present disclosure may include sensing, by the sensing unit 140, information related to a space into which light is output from the light source unit (S710).

Specifically, the light source unit 124 may include a plurality of light-emitting elements, and each of the plurality of light-emitting elements may output light to a different space (area).

The sensing unit 140 may sense information related to the space into which light is output from the light source unit.

The sensing unit 140 may sense information related to a space into which light output from the light source unit is emitted (irradiated, projected). The space may include not only the space to which the light output from the light source unit 124 is emitted, but also an area around the robot (for example, a space within a radius of a predetermined distance).

For example, the sensing unit 140 may be configured to sense an object existing in the space or to sense the environment of the space.

For this purpose, the sensing unit 140 may include at least one of the camera 121, a motion sensor, an RGB sensor, and an infrared sensor (IR sensor), an ultrasonic sensor, an optical sensor, a microphone 122, battery gauge, an environmental sensor (e.g., a barometer, a hygrometer, a thermometer, a radiation detection sensor, a heat detection sensor, a gas detection sensor, etc.) and a chemical sensor (e.g., an electronic nose, a healthcare sensor, a biometric sensor, etc.).

Additionally, the sensing unit 140 may be implemented by combining at least two of camera, radar, lidar, ultrasonic sensor, and infrared sensor included in an object detecting apparatus.

The sensing unit 140 may sense information related to the robot.

The information related to the robot may be at least one of robot information (or the driving (traveling) state of the robot) and surrounding information of the robot.

For example, the robot information may include the robot's traveling speed, the robot's weight, the number of people on board the robot, the robot's braking power, the robot's maximum braking power, the robot's driving mode (autonomous driving mode or manual driving mode), the robot's parking mode. (autonomous parking mode, automatic parking mode, or manual parking mode), whether the user is on board the robot, and information related to the user (for example, whether the user is an authenticated user).

The surrounding information of the robot may be a state of a road surface on which the robot is traveling (e.g., frictional force), the weather, a distance from a preceding (succeeding) robot, a relative speed of a preceding (succeeding) robot, a curvature of a curve when a driving lane is the curve, information associated with an object existing in a reference area (predetermined area) based on the robot, whether or not an object enters (or leaves) the predetermined area, whether or not the user exists near the robot, information associated with the user (for example, whether or not the user is an authenticated user), and the like.

In addition, the surrounding information of the robot (or surrounding environment information) may include the robot's external information (e.g., ambient brightness, temperature, sun position, information on subjects (people, other robots, signs, etc.) around the robot, the type of road surface on which the robot is traveling, terrain features, line information, and driving lane information), and information required for autonomous driving/autonomous parking/automatic parking/manual parking mode.

In addition, the surrounding information of the robot may further include a distance from an object existing around the robot to the robot, the type of the object, a parking space for the robot to be parked, an object for identifying the parking space (for example, a parking line, a string, another vehicle, a wall, etc.), and the like.

In addition, information related to the robot may include whether a mobile terminal has been mounted on a holder provided in the robot, whether the mobile terminal has entered (exists in) the robot, or whether the mobile terminal has entered (exists) within a certain distance from the robot, whether the mobile terminal and a robot control device have been connected for communication, and the like.

The information related to the robot sensed through the sensing unit may be used in an autonomous driving mode for autonomous driving of the robot. Specifically, the control unit 180 may use the information related to the robot sensed through the sensing unit 140 to make the robot travel autonomously.

The description given above may be applied in the same/similar way even when the robot is a vehicle. The present disclosure may be more appropriately applied to robots with a high degree of freedom of movement, in addition to vehicles.

As for a vehicle, there is a restriction that the vehicle must move within a roadway, so there is not great difficulty in recognizing objects within a route merely by using lighting in a direction that the vehicle moves along the route.

On the other hand, since a robot can run in any space that is empty and larger than the robot's volume, a larger area around the robot, that is, a larger area than a vehicle, must be covered with lighting.

In addition, when the robot wants to run into a space between objects, it can run in a completely different route from a direction that the robot is current traveling. Therefore, there is a need to more accurately detect the boundaries of the objects.

In other words, the robot requires a higher object class probability than the vehicle.

Additionally, the robot must ensure autonomous driving performance at night or in bad weather.

In particular, in the case of outdoor delivery robots, as user demands increase at night and in bad weather situations, more accurate object recognition is required.

To ensure visibility at night or in bad weather, a lamp is essential as an auxiliary means.

In the related art, a lamp control method was designed for human convenience, but in the era of autonomous driving, it must be developed in a direction of maximizing class probability for robots rather than for human.

The present disclosure may provide a robot capable of irradiating an optimal lamp pattern or light pattern for recognizing an object in the robot, and a method for controlling the same.

To this end, the sensing unit 140 may sense information related to a space, to which light is output from the light source unit, using at least one of the sensors described above.

The sensing unit 140 may sense environmental factors. The environmental factors may include illumination (illumination sensor), humidity (humidity sensor), temperature (temperature sensor), weather (snow/rain/fog/fine dust), time (0˜24 hours) (information reception through V2X), road slope, road surface material (e.g., generation of heat waves from asphalt (IMU sensor inside the robot), road conditions (reflection, etc.) (camera sensor), etc.

The sensing unit 140 may sense the status of the robot (e.g., robot status). For example, the robot status may include robot speed (speed sensor inside the robot), robot motion (GPS, IMU sensor), etc.

The sensing unit 140 may sense surrounding factors (e.g., surrounding robot factors), and may sense, for example, whether surrounding robots emit light (information reception through V2V).

The sensing unit 140 may sense target object factors. The target object factors may include the number of objects, the position of the object (x, y, z, deg), the type (class) of the object, the speed of the object (including dynamic and static classification), and the material of the object (reflection, etc.).

Attribute factors of the light source unit may be lamp attribute factors, and may include lamp brightness, lamp temperature, lamp angle (information reception through a sensor in the lamp), and lamp color (initial color temperature setting value of the lamp). The lamp may be the light source unit or the light-emitting element described herein.

The sensing unit 140 may detect and perceive (recognize) the approximate location of an object using an object recognition algorithm based on information related to the light source unit (e.g., headlight information of the robot) and shape information of the object, obtained through the camera.

Additionally, the control unit 180 may detect the location of an object from various sensors such as LiDAR, radar, and V2X.

In addition, the control unit 180 may predict the location of an object based on previous object detection information, detect the location of an object based on the prediction result, and determine the location of a stationary object from an HD-map.

Thereafter, in the present disclosure, the control unit 180 may control the light source unit 124 to emit light to recognize an object existing in a space through the sensing unit 140 (S720).

That is, the control unit 180 may control the light source unit 124 (to emit light) to recognize an object existing in a space to which light output from the light source unit 124 is emitted.

The control unit 180 may control at least one of the plurality of light-emitting elements so that a light pattern causing a class probability for recognizing the object to be higher than (or equal to) a preset value (or reference value, threshold) is emitted into the space (S730).

As described above, the plurality of light-emitting elements may be configured to emit light into different spaces.

Additionally, if an element emitting light among the plurality of light-emitting elements varies, the light pattern of emitted light may vary.

For example, a first light pattern emitted from a light source at a position (1, 1) and a light source at a position (1, 3) may be different from a second light pattern emitted from a light source at a position (2, 2) and a light source at a position (3, 4).

The sensing unit 140 may recognize the object when light output from the light source unit 124 is reflected back from the object.

At this time, when the light pattern of the light output from the light source unit 124 changes, a class probability for recognizing the object may vary.

The control unit 180 may control the light source unit 124 to emit a light pattern that has a maximum object class probability, on the basis of information related to the space currently sensed by the sensing unit.

To this end, the control unit 180 may randomly at least some of the plurality of light-emitting elements to emit light for a predetermined time, so that the light pattern varies.

Thereafter, the control unit 180 may extract an object class probability for each light pattern emitted to the object, and store a light pattern with the highest object class probability within the predetermined time in the memory in association with the currently sensed information related to the space.

Referring to FIG. 8, the control unit 180 may receive an image through the sensing unit 140 (e.g., the camera 124) (S810).

The control unit 180 may detect a current environment state surrounding the device (robot) based on information sensed through the sensing unit 140 (for example, the image received through the camera) (S820). That is, the control unit 180 may sense the surrounding environment information of the robot through the sensing unit.

The control unit 180 may detect the location of an object existing around the robot (existing in a space to which light output from the light source unit is emitted) and set a Region of Interest (ROI) (S830).

As an example, the ROI may include an area where the object exists. When a plurality of objects exist, the ROI may include all areas where the plurality of objects exist or an area where a specific type of object exists.

The control unit 180 may search for a lamp pattern that can maximize an object class probability in the current environment (S840).

As described above, the control unit 180 may randomly control the plurality of light-emitting elements included in the light source unit 124 in order to find a light pattern that maximizes the object class probability for a predetermined time. At this time, the types/positions/number of light-emitting elements that are arbitrarily turned on/off may vary.

Accordingly, a different light pattern may be emitted to the space, and the class probability of an object existing in the space may vary based on the variation of the light pattern.

The control unit 180 may determine a light pattern that maximizes the object class probability while varying the light pattern for the predetermined time.

Thereafter, the control unit 180 may store in the memory 170 an object recognition result, the current environment (space-related information), and a result of the light pattern (or lamp pattern for irradiating the light pattern).

Meanwhile, when the information related the light pattern corresponding to the sensed space-related information (i.e., current environment) is stored in the memory, the control unit 180 may control the light source unit to irradiate a light pattern, which corresponds to the information related to the light pattern stored in the memory, to the object.

The space-related information and the information regarding the light pattern may be linked to each other to be stored in the memory 170.

The control unit 180 may determine whether the sensed space-related information is present in the memory, based on the space-related information sensed by the sensing unit 124.

When the sensed space-related information exists in the memory, the control unit 180 may control the plurality of light-emitting elements to emit light based on the information regarding the light pattern linked to the sensed space-related information.

That is, the control unit 180 may control at least some of the plurality of light-emitting elements to irradiate light with the light pattern corresponding to the information regarding the light pattern linked to the sensed space-related information.

On the other hand, when the sensed space-related information is not present in the memory, the control unit 180 may randomly control at least some of the plurality of light-emitting elements to irradiate a plurality of random light patterns to the space, such that a light pattern causing the class probability for recognizing the object to be higher than or equal to a preset value is irradiated to the space.

When a certain light pattern, among the plurality of random light patterns, causes the class probability for recognizing the object to be higher than or equal to the preset value, the control unit 180 may store information related to the certain light pattern in the memory.

The information related to the certain light pattern may include information related to a light-emitting element that must emit light to generate the certain light pattern.

Additionally, the information related to the certain light pattern may be stored in the memory in association with the sensed space-related information.

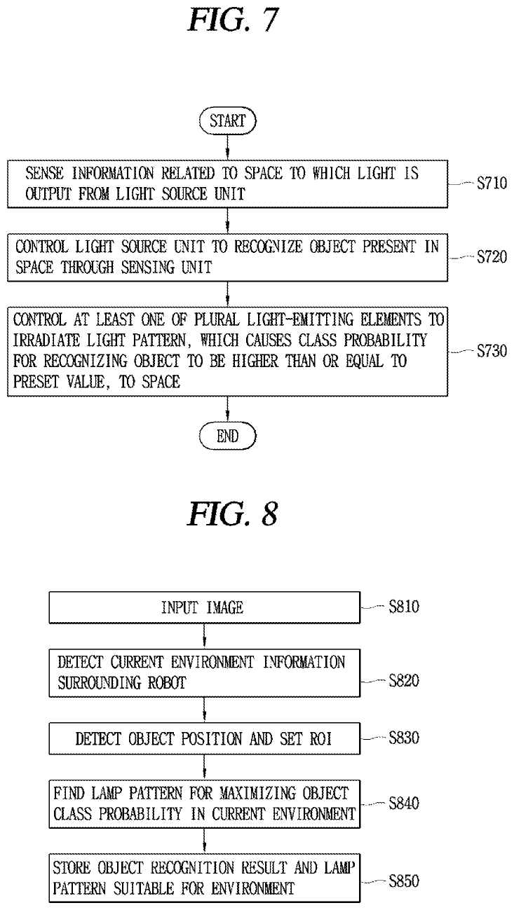

Referring to FIG. 9, the control unit 180 may sense the current state surrounding the robot using the sensing unit 140 (S910).

The control unit 180 may search for a light pattern corresponding to the current state surrounding the robot (S920).

When there is a search result of the light pattern, the control unit 180 may control the light source unit 124 to recognize an object using the searched light pattern (S930, S940).

When there is no search result, the control unit 180 may randomly generate light pattern using one or more light sources (light-emitting elements) (S950).

Thereafter, the control unit 180 may recognize an object by irradiating the randomly generated light pattern to the object (S960).

When an object class probability is not higher than (or equal to) a preset value (threshold), the control unit 180 may randomly generate another light pattern (S970). Thereafter, the control unit 180 may iterate steps S950 to S970 when the object class probability is not higher than (or equal to) the preset value. This iteration may be continued for a predetermined time.

When the object class probability is higher than (or equal to) the preset value, the control unit 180 may store information related to the corresponding light pattern in the memory (S970, S980).

The information related to the light pattern may be stored in the memory in association with the current state surrounding the robot (surrounding environment information regarding the robot).

Afterwards, the control unit 180 may use the recognition result to make the robot travel autonomously or use information related to the object in various ways (S990).

That is, the control unit 180 may search for a lamp pattern suitable for the current environment from a DB (or cloud), and use the searched lamp pattern when there is a search result.

The control unit 180 may perform the random pattern generation when there is no search result, and may iterate the random pattern generation until the class probability is sufficiently secured.

When the class probability is higher than (or equal to) the preset threshold, the control unit 180 may update the pattern in DB (or cloud) and derive a recognition result.

Meanwhile, the control unit 180 may sense the movement of the object existing in the space through the sensing unit 140.

The control unit 180 may predict an area where the object is to be located after a predetermined time based on the sensed movement.

When the object is located in the predicted area, the control unit 180 may control at least one of the plurality of light-emitting elements to irradiate a light pattern, which causes the class probability of recognizing the object to be higher than (or equal to) the preset value, to the predicted area.

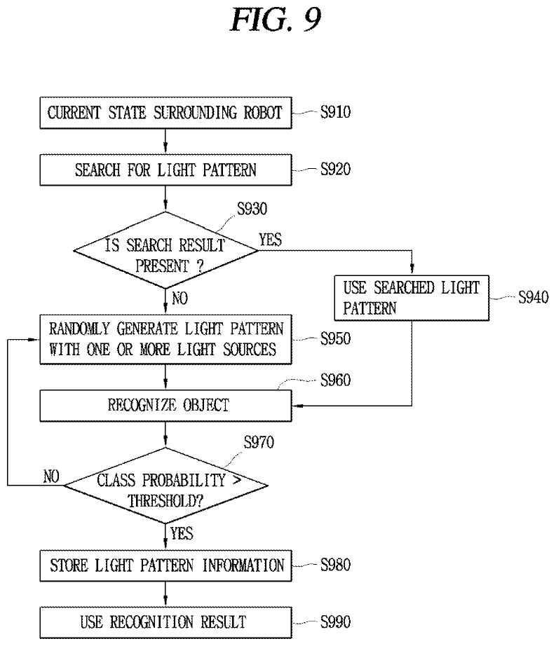

Referring to FIG. 10, when the robot is traveling, for example, traveling at high speed, it is generally a situation that both the robot and a surrounding object are moving quickly in a road environment such as a highway or automobile road.

Since both the robot (e.g., robot or vehicle) and the surrounding object are moving quickly at the same time, the control unit 180 may measure both movement information regarding the robot and movement information regarding the surrounding object, and then calculate relative movement information regarding the surrounding object.

Since the robot and surrounding object move fast, the control unit 180 may calculate in advance a light emission area (or lamp projection area) to obtain a high class probability by predicting the movement of the surrounding object.

In order to calculate the light irradiation area in advance, it is important to predict a movement path of the surrounding object in advance.

To this end, the control unit 180 may recognize the traveling direction of the surrounding object, that is, whether the surrounding object moves in a forward direction like the robot or in a reverse direction to the robot, and predict in advance a path along which the surrounding object is expected to move by referring to map information, etc.

For example, the control unit 180 may predict the location of the object after a predetermined time based on road curvature information on the map and past speed information regarding the object, and generate and irradiate a light pattern (lamp pattern) to cover a corresponding area so that the class probability does not decrease.

To this end, as illustrated in FIG. 10, the control unit 180 may measure movement information regarding the robot (S1010) and measure movement information regarding the surrounding object through the sensing unit (S1020).

Afterwards, the control unit 180 may predict information regarding the location of the surrounding object after a predetermined time (S1030), generate a light pattern to increase the class probability for the surrounding object including the predicted location (area), and then irradiate the generated light pattern to the surrounding object (S1030, S1040, S1050).

On the other hand, when the robot is traveling at low speed, the robot's movement is not great at the low speed, so the robot's status does not have a significant effect on recognizing the object. Therefore, compared to normal driving, the control unit 180 may lower the weight of the robot status upon the random pattern generation, and highly consider the weights of environmental factors as the weight of the robot status is lowered.

In particular, the control unit 180 may increase the weights of illumination, weather, road slope, road surface, and road condition, and may increase the weights of target object factors upon the random pattern generation because the classification probability of the target object increases at low speed compared to high speed.

For example, the control unit may increase a preset value that is a reference for the object class probability when the robot is in a stationary state without movement, while decreasing the preset value when the robot moves.

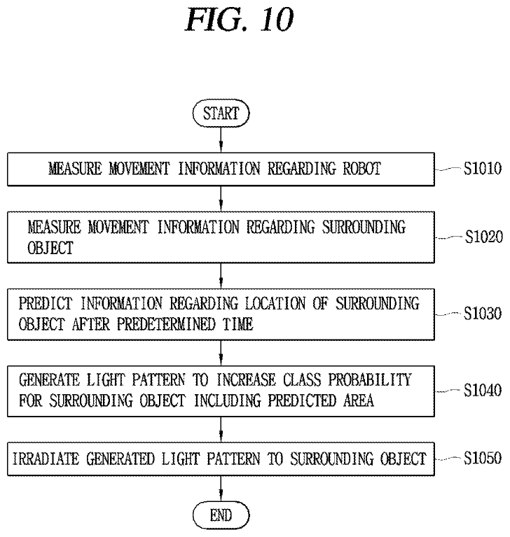

Referring to FIG. 11, the control unit 180 may receive (sense) environmental factors through a sensor (sensing unit) or V2X (Vehicle to Everything) communication (S1110). The environmental factors may include illumination, humidity, temperature, weather, time, road slope, road surface, road condition, etc.

The control unit 180 may identify target object factors through the sensor (S1120). For example, the control unit 180 may identify the number of objects, position, speed, material, etc.

The control unit 180 may generate a random light pattern for a similar environment (S1130). When information related to a light pattern corresponding to the environmental factors and the target object factors exists in the memory, the control unit 180 may control the light source unit 124 to generate the corresponding light pattern.

The control unit 180 may identify the robot status and surrounding robot factors through the sensor and V2V (Vehicle to Vehicle) communication, and identify attribute factors of the lamp (light source unit) (S1140, S1150).

The control unit 180 may adjust the brightness of the light pattern for the similar environment (S1160).

Meanwhile, since there is no motion parameter while the robot is stopped, parameters related to the surrounding environment may be utilized as much as possible.

The control unit 180 may search for an optimal light pattern by using more diverse random patterns because a great change in surroundings does not occur without the motion of the robot. Accordingly, the control unit 180 may verify all patterns or perform the search until the robot moves.

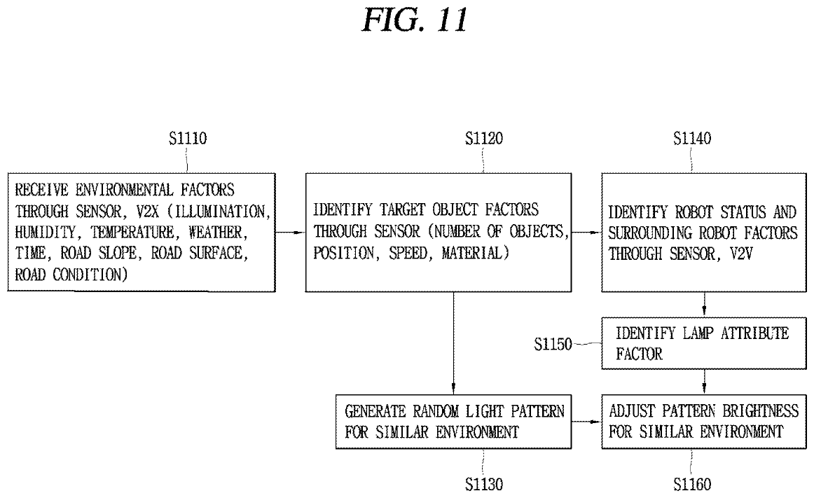

Referring to FIG. 12, the control unit 180 may receive environmental factors through the sensor or V2X communication (S1210) and identify target object factors through the sensor (S1220).

Thereafter, the control unit 180 may determine whether a light pattern (i.e., lamp pattern) corresponding to the environmental factors and the target object factors exists in the memory, and when no light pattern exists, generate random light patterns (S1230, S1240).

The control unit 180 may recognize an object to which the random light patterns are emitted and determine an optimal light pattern with a class probability higher than (or equal to) a preset value (S1250, 1260).

Thereafter, the control unit 180 may perform verification on all light patterns or terminate the light pattern search process when the motion of the robot is detected (S1270, S1280).

Meanwhile, when the robot is being parked, the robot's speed is low (less than 30 kph), and thus environmental factors, surrounding robot factors, and target object factors have a greater influence on object recognition than the robot's status.

When the parking lot is indoor, indoor illumination, surrounding robot factors, and road surface conditions among environmental factors have a greater influence on object recognition. Accordingly, the control unit 180 may increase the weights of related parameters.

When the parking lot is outdoor, weather, outdoor illumination, humidity, temperature, surrounding robot factors, and road surface conditions among environmental factors have a greater influence on object recognition. Accordingly, the control unit 180 may increase the weights of related parameters.

The control unit 180 may perform search for an optimal light pattern using various random patterns until all patterns are verified or a parking area is found.

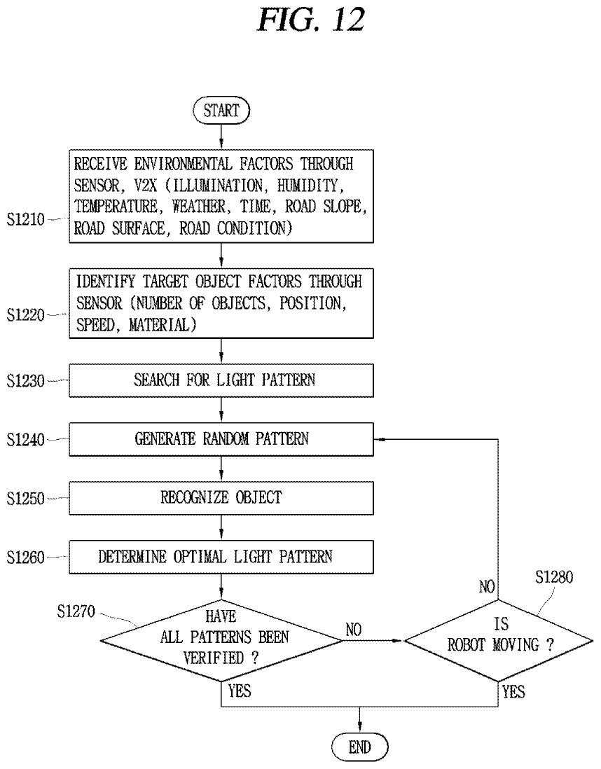

Referring to FIG. 13, the control unit 180 may receive environmental factors through the sensor or V2X communication and identify target object factors through the sensor (S1310, S1320).

Thereafter, when the robot is in an indoor parking lot, the control unit 180 may increase the weights for indoor illumination, surrounding robot factors, and road surface conditions (S1330, S1340).

On the other hand, when the robot is in an outdoor parking lot, the control unit 180 may increase the weights for weather, outdoor illumination, humidity, temperature, surrounding robot factors, and road surface conditions (S1330, S1350).

With the weights increased, the control unit 180 may search for a light pattern, generate random light patterns, and determine an optimal light pattern after object recognition (S1360, S1370, S1380, S1390).

In the present disclosure, determining the optimal light pattern may indicate determining a light pattern with an object class probability higher than (or equal to) a preset value (threshold) or selecting (determining) a light pattern with the highest object class probability among a plurality of random light patterns emitted within a predetermined time.

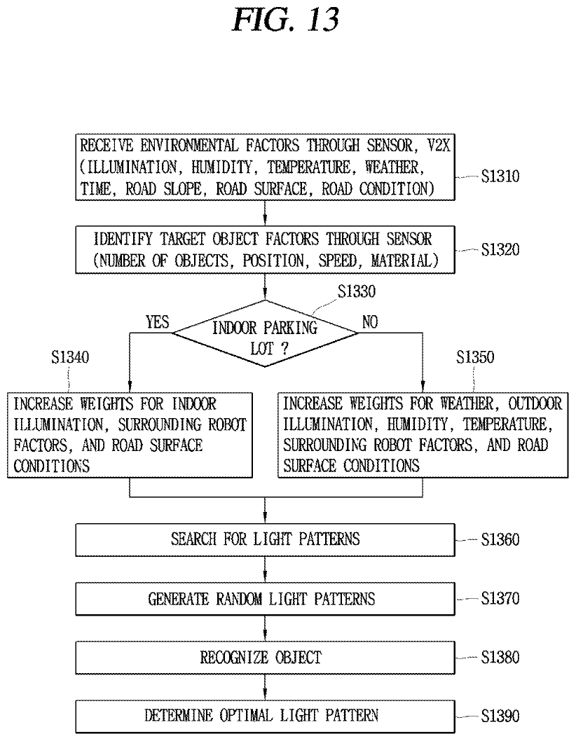

As illustrated in FIG. 14, the control unit 180 may control a plurality of light-emitting elements, which irradiate light, of the light source unit 124, so that a light pattern emitted to an object varies.

For example, three light patterns illustrated in FIG. 14 may be randomly emitted light patterns, and when a light pattern emitted to the object changes, an object class probability may vary.

The control unit 180 may vary the light pattern by arbitrarily emitting light from the plurality of light-emitting elements to determine a light pattern with the highest object class probability.

Meanwhile, according to the present disclosure, when a plurality of objects exist in a space to which light output from the light source unit is emitted, the control unit may control the light source unit to have an optimized object class probability.

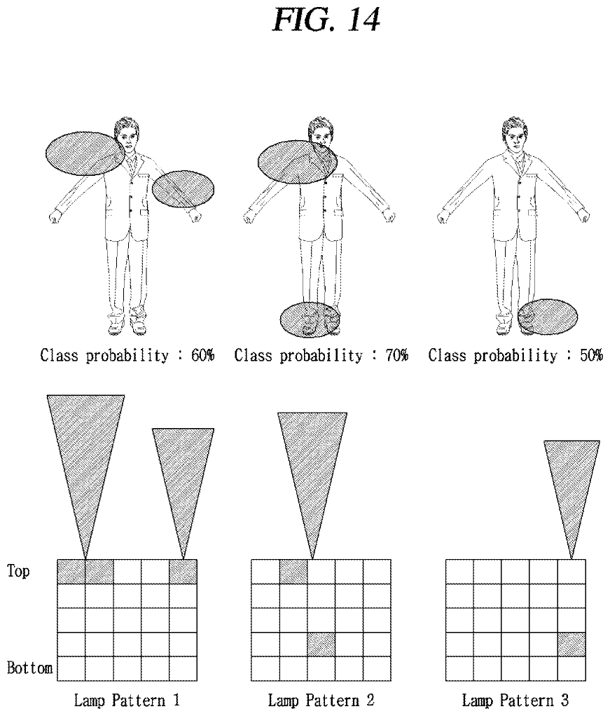

FIGS. 15, 16, and 17 are conceptual diagrams and a flowchart for explaining an object recognition method in accordance with another embodiment of the present disclosure.

Referring to FIG. 15, when a plurality of objects exist in a space to which light output from the light source unit is emitted, the control unit 180 may determine whether the objects existing in the space are of (belong to) the same class (type).

Thereafter, the control unit 180 may control the light source unit to recognize an object existing in the space in a first object recognition mode or a second object recognition mode, based on the determination result.

As illustrated in FIG. 15, when a plurality of objects (e.g., human) of the same class exist in the space to which light is output from the light source unit, the control unit 180 may determine the object class probability of each object.

Thereafter, in the case of a single class of objects, the control unit 180 may derive an optimal lamp pattern (light pattern) based on the average of object class probabilities of the plurality of objects (N objects).

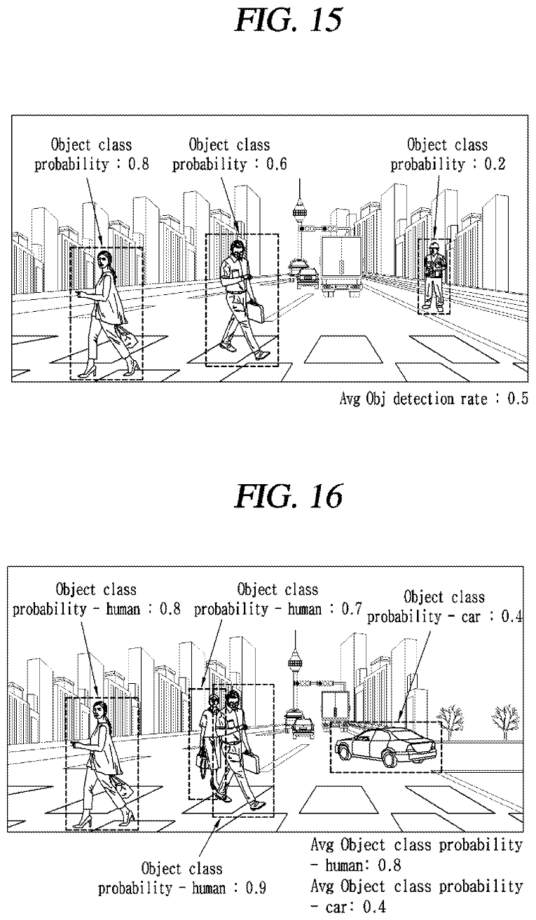

On the other hand, as illustrated in FIG. 16, when a plurality of objects belonging to various classes exist in the space, the control unit 180 may extract the object class probability of each object, and derive an optimal lamp pattern (light pattern) based on the average of object class probabilities for each class of the plurality of objects.

To this end, when the plurality of objects existing in the space are of different classes, the control unit 180 may recognize the objects in the first object recognition mode, and when the plurality of objects existing in the space are of the same class, the control unit 180 may recognize the objects in the second object recognition mode.

The first object recognition mode may be a mode of extracting object class probabilities for each class, and recognizing the objects based on the object class probabilities extracted for each class.

In the first object recognition mode, the control unit 180 may extract the object class probabilities for each class (type) and control the light source unit so that the average of the extracted class probabilities of the objects for each class exceeds a threshold for each class.

When entering the first object recognition mode, the control unit 180 may control at least some of the plurality of light-emitting elements to emit light, to determine a light pattern that causes the average of object class probabilities for each class to exceed the threshold for each class.

The first object recognition mode may be a selective method, and may be a mode in which objects are recognized based on whether an object class probability for each type (or class) exceeds a threshold for each type.

Meanwhile, the second object recognition mode may be a mode that recognizes objects based on the class probabilities for a plurality of objects of the same type.

In the second object recognition mode, the control unit 180 may extract class probability for each of a plurality of objects and control the light source unit so that the average of the extracted class probabilities exceeds a threshold.

When entering the second object recognition mode, the control unit 180 may control at least some of the plurality of light-emitting elements to emit light, to determine a light pattern that causes the average of object class probabilities for the plurality of objects to exceed the threshold.

The second object recognition mode may be a normalized method. Since it is a mode that recognizes a plurality of objects of a single class, the second object recognition mode may be a mode that recognizes objects based on the average of class probabilities of the plurality of objects.

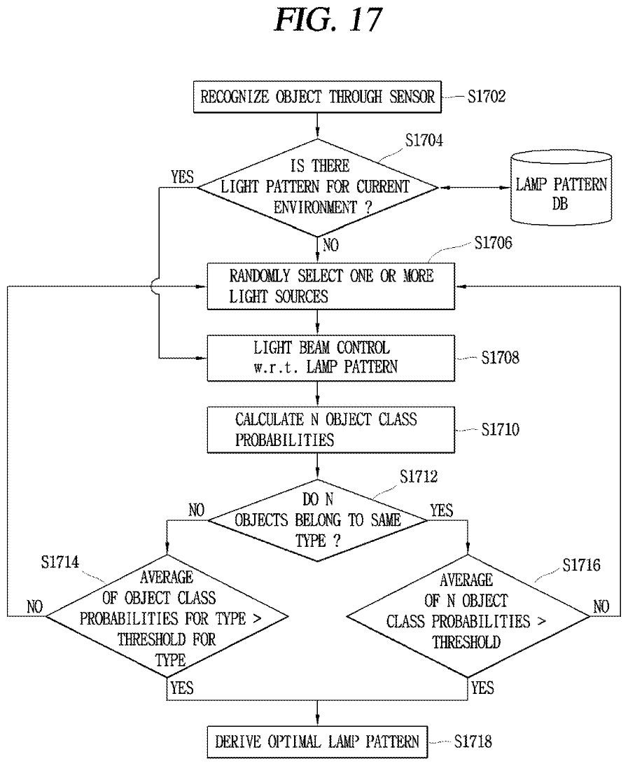

Referring to FIG. 17, the control unit 180 may recognize (detect, perceive) objects through the sensing unit (S1702).

The control unit 180 may sense information regarding a current environment (space-related information) through the sensing unit 140, and determine whether there is a light pattern for the current environment (i.e., information related to a light pattern corresponding to information related to the current space) (S1704).

When there is the information related to the light pattern corresponding to the information related to the current space, the control unit 180 may control the light source unit 124 so that the light pattern corresponding to the information related to the light pattern is emitted to the objects (S1708).

Meanwhile, when there is no information related to the light pattern corresponding to the information related to the current space, the control unit 180 may randomly select one or more light sources (light-emitting elements) to irradiate a random light pattern to the objects (S1706, S1708).

Afterwards, the control unit 180 may calculate class probabilities for a plurality of objects, respectively (S1710).

The control unit 180 may determine whether the types (or classes) of the plurality of objects existing in the space are the same (S1712) and recognize the objects in the first object recognition mode or the second object recognition mode depending on whether they belong to the same type.

For example, when the types of the plurality of objects are different, the control unit 180 may recognize the objects using the first object recognition mode (Selective method) (S1714).

As an example, the control unit 180 may determine whether the average object class probability for each type exceeds a threshold for each type.

When the average object class probability for each type exceeds the threshold for each type, the control unit 180 may derive the corresponding light pattern as an optimal light pattern (lamp pattern) (S1718).

When the average object class probability for each type exceeds the threshold for each type, the control unit 180 may store information related to the corresponding light pattern in the memory in association with the information related to the type of objects and the current space.

On the other hand, when the types (classes) of the plurality of objects are the same, the control unit 180 may recognize the objects using the second object recognition mode (Normalized method) (S1716).

As an example, the control unit 180 may determine whether the average of the object class probabilities of the same type of objects exceeds the threshold.

When the average object class probability of the same type exceeds the threshold, the control unit 180 may derive the corresponding light pattern as an optimal light pattern (lamp pattern) (S1718).

When the average object class probability of the same type exceeds the threshold, the control unit 180 may store information related to the corresponding light pattern in the memory in association with the information related to the type of objects and the current space.

The control unit 180 may recognize objects through a sensor and search for whether a lamp pattern DB for the current environment exists in a lamp pattern DB built by learning existing data.

When the lamp pattern DB exists, the control unit 180 may control the light source unit 124 to irradiate a light pattern corresponding to the lamp pattern DB.

When the lamp pattern DB does not exist, the control unit 180 may control the light source unit 124 to irradiate a random light pattern by randomly selecting one or more light-emitting elements.

The control unit 180 may calculate class probabilities for N objects (object class probabilities) based on image data according to the emitted light pattern.

When there are a plurality of objects, the control unit 180 may classify the N objects by type.

When the N objects are all of the same type, the control unit 180 may control lamp brightness to overall improve the object class probabilities for the N objects.

When the average class probability of the N objects is higher than (or equal to) the threshold, the control unit 180 may select the corresponding lamp pattern as an optimal lamp pattern. (Normalized Method)

When the N objects are of different types, the control unit 180 may control the lamp brightness to selectively improve the object class probabilities according to importance of the object type.

For example, the control unit 180 may assign a high class probability threshold when the object type involves a person, such as pedestrian, bicyclist, or cyclist.

The control unit 180 may select the corresponding lamp pattern as an optimal lamp pattern when the average object class probability for each type is higher than (or equal to) the threshold for each type. (Selective Method)

In the first object recognition mode, the control unit 180 may control the light source unit based on the object class probability of a type with the highest priority, with respect to different types of objects.

The control unit 180 may control the light source unit to emit a light pattern that causes the object class probability of the type with the highest priority to exceed the threshold.

Meanwhile, the control unit 180 may vary the threshold of the object class probability based on the types of the plurality of objects in the first object recognition mode.

For example, the control unit 180 may set the threshold for recognizing the objects to a first threshold, and when a preset type of object is included in the plurality of objects, set the threshold to a second threshold higher than the first threshold.

When the preset type of object is included in the plurality of objects, the control unit 180 may control the light source unit to emit a light pattern that causes the object class probability is higher than the second threshold.

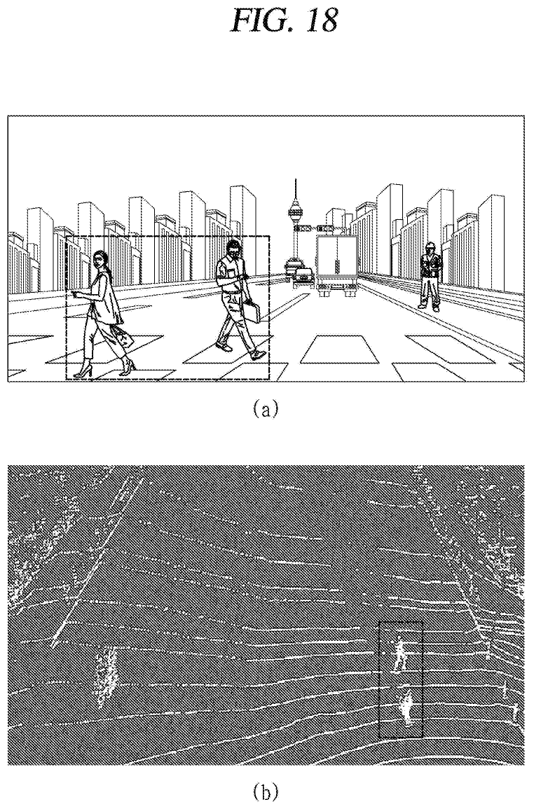

FIGS. 18, 19, 20, 21, 22, 23, 24, and 25 are conceptual diagrams and flowcharts for explaining various object recognition methods in accordance with the present disclosure.

The control unit 180 may set an ROI in a space to which light is emitted from the light source unit.

The control unit 180 may generate a light pattern within the ROI.

Referring to FIG. 18, when one object is detected, the control unit 180 may set an ROI based on the detected object and emit a random light pattern centered on the set ROI.

When a plurality of objects are detected, the control unit 180 may set a 3D ROI based on the detected objects and emit a random light pattern centered on the set ROI.

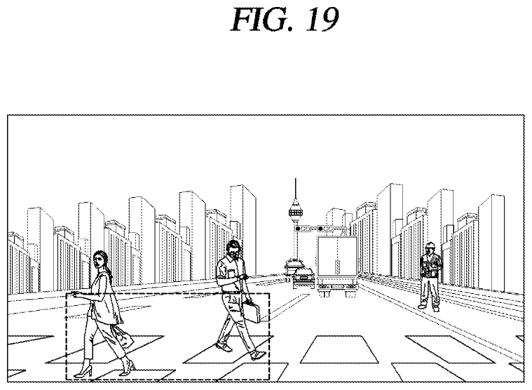

Referring to FIG. 19, when a person is included in a single object or a plurality of objects, the control unit 180 may set (adjust) the ROI so that light is not emitted to an upper body.

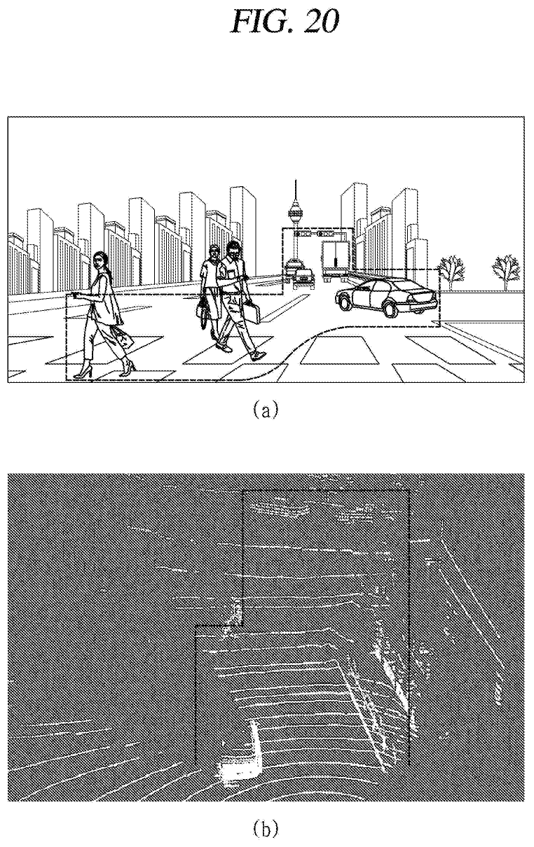

Referring to FIG. 20, when there is a robot or person in an opposite lane between objects, the control unit 180 may set an ROI so that light is not directly emitted to the robot or the upper body of the person, and control the light source unit 124 to emit light to the set ROI.

For example, the control unit 180 may increase lamp brightness or emit high beam light after the robot or person passes by.

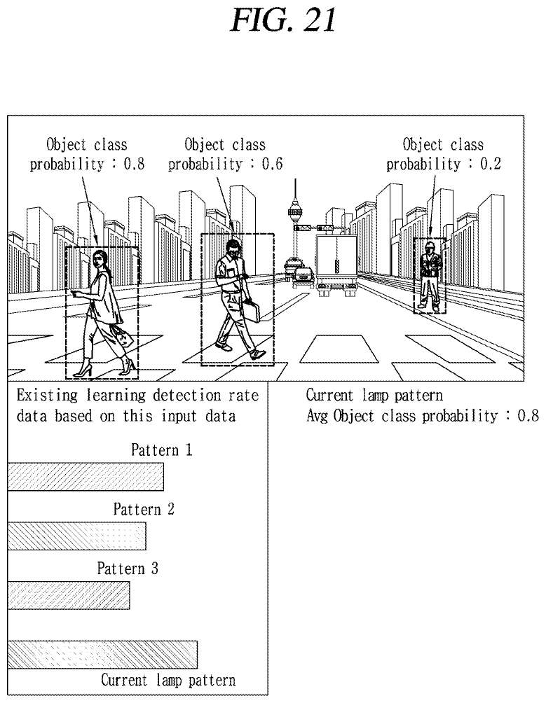

Referring to FIG. 21, the control unit 180 may search for (determine) a light pattern by analyzing sensed information (input image) based on previously learned data.

Data used for learning may include the environmental factors, the status of the object recognition device (robot), the surrounding robot factors, the target object factors, the lamp attributes, etc., which have been described above.

The control unit 180 may input, as input data, information related to the objects sensed through the sensing unit and irradiate a random light pattern to the objects based on the learned data.

At this time, the input value may include the distance, number, type, etc. of the objects.

When the average object class probability is higher than the object class probability of the light pattern, which has been learned previously, when irradiating the random light pattern to the set ROI, the control unit 180 may learn information related to the random light pattern.

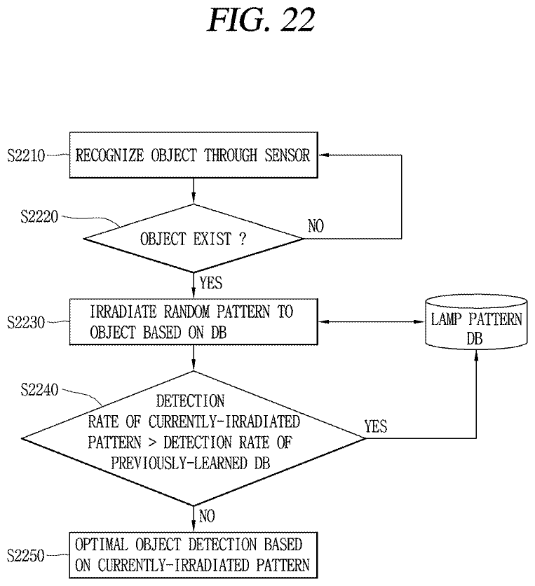

Referring to FIG. 22, the control unit 180 may recognize objects through the sensing unit. When objects exist, the control unit 180 may irradiate a random light pattern to the objects based on information related to a current state and types of the objects, stored in the memory (S2210, S2220, S2230).

When the object class probability of the random light pattern is higher than the object class probability of the light pattern, which has been learned and stored, the control unit 180 may store information related to the random light pattern in the memory (S2240).

When the object class probability of the currently emitted random light pattern is lower than the object class probability of the previously learned light pattern, the control unit 180 may perform object recognition based on the currently emitted light pattern or after controlling the light source unit to irradiate the learned light pattern (S2250).

When creating a lamp pattern (in the case of lamp pattern initialization), the control unit 180 may recognize the current surrounding environment of the robot using the sensors inside the device or external infrastructures (V2V, V2I), search for whether a lamp pattern for the current environment is present in a lamp pattern DB or a lamp pattern cloud, and randomly generate one or more light sources through a lamp pattern generation when the lamp pattern does not exist in the DB.

When the object class probability decreases below the threshold, 2) the control unit 180 may randomly generate one light source through a lamp pattern generation (Lamp pattern re-generation).

The control unit 180 may iterate the lamp pattern generation until the object class probability is higher than (or equal to) the set threshold (Lamp pattern generation iteration)

When the class probability is higher than (or equal to) the threshold, the control unit 180 may update the lamp pattern in the DB (or Cloud).

The control unit 180 may re-perform the lamp pattern generation when the class probability is below the threshold and the object is in a camera FOV or lamp projection area.

The control unit 180 may terminate the lamp pattern generation when the class probability is below the threshold and the object is out of the camera FOV or lamp projection area.

Meanwhile, the control unit 180 may irradiate a light pattern that causes the class probability to be higher than (or equal to) a preset value while tracking objects existing in a space using the sensing unit. Thereafter, the control unit 180 may generate a new light pattern when the objects being tracked disappear.

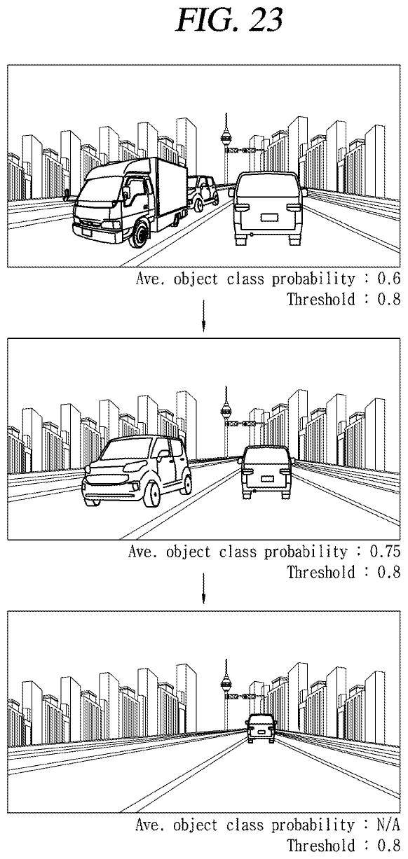

Referring to FIG. 23, in case where T=t and iteration=1 in the first drawing, the control unit 180 may perform the lamp pattern re-generation due to the class probability decreasing below the threshold.

In case where T=t+1 and iteration=10 in the second drawing, the control unit 180 may re-perform the lamp pattern generation when the class probability is lower than the threshold and the objects exist within the camera FOV.

In case where T=t+2 and iteration=20 in the third drawing, the control unit 180 may terminate the lamp pattern generation when the class probability is lower than the threshold and the objects are out of the camera FOV.

Meanwhile, the control unit 180 may control a light pattern generation in various ways depending on whether the robot moves and depending on an object tracking result.

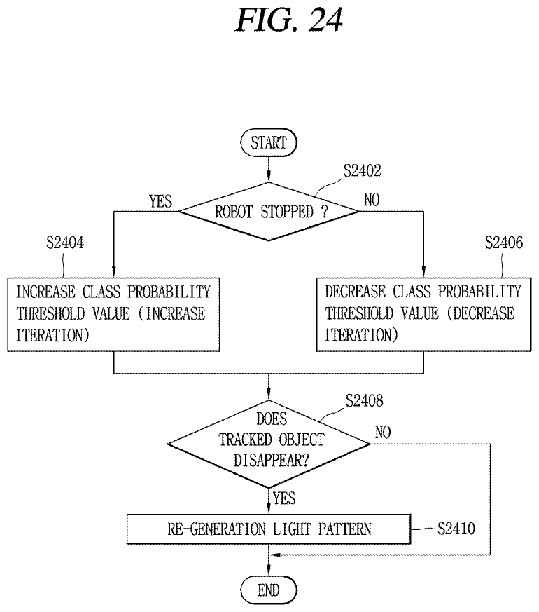

Referring to FIG. 24, the control unit 180 may determine whether the device (robot) is stopped through the sensing unit, and if so, may increase the threshold of the object class probability (S2402, S2404).

On the other hand, the control unit 180 may lower the threshold of the object class probability when it is determined through the sensing unit that the device moves (S2406).

The control unit 180 may generate a new light pattern when the object being tracked through the sensing unit disappears (S2408, S2410).

When the robot is not stopped, that is, when the robot is moving, blurring may occur in the sensing input for the object due to the motion of the robot, which may lower the object class probability. Therefore, the control unit 180 may lower the detection threshold to prevent recognition failure. In the opposite case, that is, when the robot is stopped, the control unit 180 may increase the detection threshold.

When the object being tracked disappears, the control unit 180 may generate a new light pattern suitable for a given environment because the existing light pattern generated for the object cannot be used.

Meanwhile, when at least one of the light-emitting elements for irradiating the light pattern is broken, the control unit 180 may control at least one of the light-emitting elements adjacent to the broken light-emitting element to irradiate a light pattern corresponding to the light pattern.

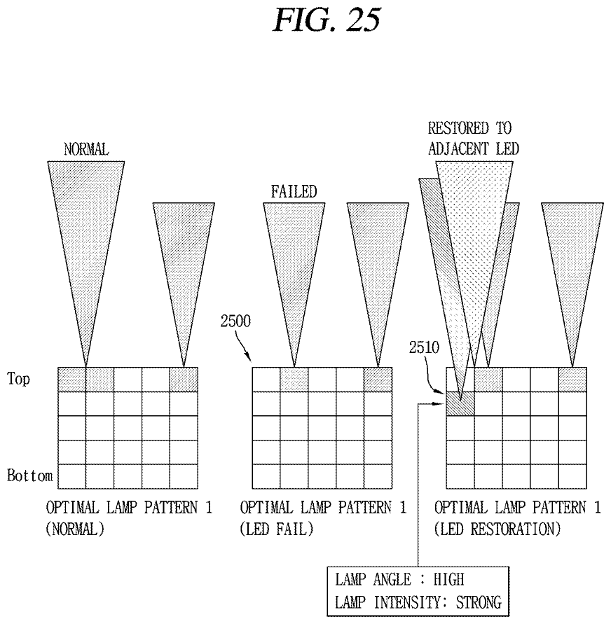

Referring to FIG. 25, the control unit 180 may utilize another light source upon a failure of one of light-emitting elements 2500 for irradiating a light pattern that causes an object class probability to be higher than (or equal to) a preset value.

When the light source 2500 selected to irradiate the corresponding light pattern fails, the control unit 180 may utilize another light source 2510.

For example, if a light-emitting element (LED) for irradiating an optimal lamp pattern fails, the control unit 180 may select another LED adjacent to the failed LED.

The control unit 180 may adjust a lamp angle within the selected adjacent LED in the lamp direction of the failed LED.

The control unit 180 may adjust lamp intensity in the selected adjacent LED to be stronger than that in the existing LED.

The control unit 180 may implement a lamp pattern similar to an optimal lamp pattern using the selected adjacent LED by adjusting the LED characteristics of the selected adjacent LED.

Through this, the present disclosure can perform optimal lamp brightness control by utilizing an adjacent LED even when an LED fails.

Hereinafter, effects of a robot and a method for controlling the same according to the present disclosure will be described.

According to at least one of embodiments of the present disclosure, a new robot that is capable of maintaining an object class probability to be higher than (or equal to) a threshold by utilizing lighting when recognizing objects, and a method for controlling the same can be provided.

The present disclosure can perform object recognition in an optimized manner by performing a lighting control differently depending on types of objects even when a plurality of objects exist.

The present disclosure can be implemented as computer-readable codes in a program-recorded medium. The computer readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The computer may also include the control unit 180 of the robot. Therefore, the detailed description should not be limitedly construed in all of the aspects, and should be understood to be illustrative. The scope of the present disclosure should be determined by reasonable interpretation of the appended claims, and all changes within the equivalent scope of the present disclosure are embraced by the appended claims.

1. A robot comprising:
a light source unit that has a plurality of light-emitting elements;
a sensing unit that senses information related to a space to which light is output from the light source unit; and
a control unit that controls the light source unit to emit light to recognize objects existing in the space through the sensing unit,
wherein the control unit controls at least one of the plurality of light-emitting elements to emit light so that a light pattern that causes a class probability of recognizing the objects to be higher than or equal to a preset value is irradiated to the space.

2. The robot of claim 1, wherein the plurality of light-emitting elements are each configured to emit light into different spaces, and
a light pattern of the emitted light varies when an element emitting light among the plurality of light-emitting elements changes.

3. The robot of claim 1, wherein the sensing unit recognizes the object based on light emitted from the light source unit being reflected back from the object, and
the class probability for recognizing the object varies when the light pattern of the light output from the light source unit changes.

4. The robot of claim 1, further comprising a memory that stores information related to a space and information related to a light pattern in association with each other,
wherein the control unit determines whether the sensed information related to the space exists in the memory, based on the information related to the space sensed by the sensing unit.

5. The robot of claim 4, wherein the control unit, when the sensed information related to the space exists in the memory, controls the plurality of light-emitting elements to emit light based on the information related to the light pattern associated with the sensed information related to the space.

6. The robot of claim 5, wherein the control unit controls at least some of the plurality of light-emitting elements to emit light with a light pattern corresponding to the information related to the light pattern linked to the sensed information related to the space.

7. The robot of claim 4, wherein the control unit, when the sensed information related to the space is not present in the memory, randomly controls at least some of the plurality of light-emitting elements to emit a plurality of random light patterns to the space, such that a light pattern causing the class probability for recognizing the object to be higher than or equal to a preset value is irradiated to the space.

8. The robot of claim 7, wherein when a certain light pattern, among the plurality of random light patterns, causes the class probability for recognizing the object to be higher than or equal to the preset value, the control unit stores information related to the certain light pattern in the memory.

9. The robot of claim 8, wherein the information related to the certain light pattern includes information related to a light-emitting element that must emit light to generate the certain light pattern.

10. The robot of claim 9, wherein the information related to the certain light pattern is stored in the memory in association with the sensed information related to the space.

11. The robot of claim 1, wherein the control unit senses a motion of the object existing in the space through the sensing unit and predicts an area where the object is to be located after a predetermined time based on the sensed motion.

12. The robot of claim 11, wherein the control unit, when the object is located in the predicted area, controls at least one of the plurality of light-emitting elements to irradiate a light pattern, which causes the class probability of recognizing the object to be higher than or equal to the preset value, to the predicted area.

13. The robot of claim 1, wherein the control unit increases the preset value when the robot is in a stationary state without movement, while decreasing the preset value when the robot moves.

14. The robot of claim 1, wherein the control unit irradiates a light pattern causing the class probability to be higher than or equal to a preset value while tracking the object existing in the space using the sensing unit, and generates a new light pattern when the object being tracked disappears.

15. The robot of claim 1, wherein the control unit, when at least one of light emitting elements for emitting the light pattern fails, controls at least one of the light-emitting elements, adjacent to the failed light-emitting element, to emit light, and
controls the at least one of the adjacent light-emitting elements to emit a light pattern corresponding to the light pattern.

16. A robot comprising:
a light source unit that has a plurality of light-emitting elements;
a sensing unit that senses information related to a space to which light is output from the light source unit; and
a control unit that controls the light source unit to emit light to recognize an object existing in the space through the sensing unit,
wherein the control unit, when a plurality of objects exist in the space, determines whether types of the objects existing in the space are the same, and
controls the light source unit to recognize the objects existing in the space in a first object recognition mode or a second object recognition mode based on a result of the determination.

17. The robot of claim 16, wherein the control unit recognizes the plurality of objects existing the space in the first object recognition mode when the plurality of objects existing in the space are of different types, and
recognizes the plurality of objects existing the space in the second object recognition mode when the plurality of objects existing in the space are of the same type.

18. The robot of claim 17, wherein the first object recognition is a mode of extracting object class probabilities for each type, and recognizing the objects based on the object class probabilities extracted for each type.

19. The robot of claim 18, wherein the control unit, in the first object recognition mode, extracts the object class probabilities for each type and controls the light source unit so that an average of the extracted object class probabilities for each class exceeds a threshold for each type.

20. The robot of claim 19, wherein the control unit, when entering the first object recognition mode, controls at least some of the plurality of light-emitting elements to emit light, to determine a light pattern that causes the average of the object class probabilities for each type to exceed the threshold for each type.

21. The robot of claim 17, wherein the second object recognition mode is a mode of recognizing objects based on class probabilities for the plurality of objects of the same type.

22. The robot of claim 21, wherein the control unit, in the second object recognition mode, extracts a class probability for each of a plurality of objects and controls the light source unit so that an average of the extracted class probabilities exceeds a threshold.

23. The robot of claim 22, wherein the control unit, when entering the second object recognition mode, controls at least some of the plurality of light-emitting elements to emit light, to determine a light pattern that causes the average of the object class probabilities of the plurality of objects to exceed the threshold.

24. The robot of claim 16, wherein the control unit, in the first object recognition mode, controls the light source unit based on an object class probability of a type with a highest priority, with respect to different types of objects.

25. The robot of claim 24, wherein the control unit controls the light source unit to emit a light pattern that causes the object class probability of the type with the highest priority exceeds the threshold.

26. The robot of claim 16, wherein the control unit varies a threshold of an object class probability based on the types of the plurality of objects in the first object recognition mode.

27. The robot of claim 26, wherein the control unit sets the threshold for recognizing the objects to a first threshold, and when a preset type of object is included in the plurality of objects, sets the threshold to a second threshold higher than the first threshold.

28. The robot of claim 27, wherein the control unit, when the preset type of object is included in the plurality of objects, controls the light source unit to irradiate a light pattern that causes the object class probability is higher than the second threshold.
